(19) United States
(12) Patent Application Publication
(10) Pub. No.: US 2025/0310153 A1
(43) Pub. Date: Oct. 2, 2025

(54) SYSTEMS AND METHODS FOR ESTIMATING NOISE VARIANCE

(71) Applicant: Skyworks Solutions, Inc., Irvine, CA (US)

(72) Inventors: Alexander Kleinerman, Austin, TX (US); Bradley Arthur Wallace, Austin, TX (US)

(21) Appl. No.: 19/075,162

(22) Filed: Mar. 10, 2025

Related U.S. Application Data
(60) Provisional application No. 63/571,903, filed on Mar. 29, 2024.

(51) Int. Cl. H04L 25/02; H04B 1/16

(52) U.S. Cl. CPC H04L 25/0222; H04B 1/16

(57) ABSTRACT

Systems and methods for estimating noise variance are provided. In one aspect, an apparatus includes a front end circuit configured to receive a radio frequency signal and process the radio frequency signal into a plurality of samples and a transform engine configured to convert at least one of the samples into a plurality of frequency carriers. The apparatus further includes a detector configured to determine a channel estimate for a subset of the frequency carriers located within an evaluation window, select one of the carriers within the evaluation window, determine differences between the channel estimate of the selected carrier and the channel estimates of other carriers within the evaluation window, and estimate the noise variance for a symbol including the at least one of the samples based on the differences between the channel estimate of the selected carrier and the channel estimates of other frequency carriers within the evaluation window.

### CROSS-REFERENCE TO RELATED APPLICATION(S)

Any and all applications for which a foreign or domestic priority claim is identified in the Application Data Sheet as filed with the present application are hereby incorporated by reference under 37 CFR 1.57.

### BACKGROUND

### Field

Embodiments of this disclosure relate to techniques for estimating noise variance that can be used, for example, in digital radios.

### Description of the Related Technology

Radio receivers are omnipresent in modern technology. In addition to standalone radios for receipt of broadcast radio signals, all manners of tech and non-tech devices include some type of radio receiver (and often paired with a transmitter). Such modem circuitry is present in any device having wireless capabilities. While some broadcast radio signals are transmitted with analog coding (e.g., conventional AM and FM signals), other terrestrial and satellite wireless communication systems use some type of digital encoding. Some example digital radio systems include National Radio System Committee (NRSC-5C, also known as HD™ radio), Digital Audio Broadcasting (DAB), Digital Radio Mondiale (DRM) or other standard.

### SUMMARY OF CERTAIN INVENTIVE ASPECTS

The innovations described in the claims each have several aspects, no single one of which is solely responsible for its desirable attributes. Without limiting the scope of the claims, some prominent features of this disclosure will now be briefly described.

One aspect of this disclosure is an apparatus comprising: a front end circuit configured to receive a radio frequency signal and process the radio frequency signal into a plurality of samples; a transform engine coupled to the front end circuit and configured to convert at least one of the samples into a plurality of frequency carriers; and a detector coupled to the transform engine and configured to determine a channel estimate for a subset of the frequency carriers located within an evaluation window, select one of the carriers within the evaluation window, determine differences between the channel estimate of the selected carrier and the channel estimates of other carriers within the evaluation window, and estimate noise variance for a symbol including the at least one of the samples based on the differences between the channel estimate of the selected carrier and the channel estimates of other frequency carriers within the evaluation window.

In some embodiments, the detector is further configured to determine the noise variance for at least two symbols.

In some embodiments, the detector is further configured to determine a filtered noise variance for the radio frequency signal by applying an infinite impulse response filter to the noise variance for at least two symbols.

In some embodiments, the detector is further configured to determine a square of each of the determined differences, sum the squares of the determined differences, and divide the sum by a total number of the determined differences, the estimation of the noise variance is further based on the sum the squares of the determined differences divided by the total number of the determined differences.

In some embodiments, the detector is further configured to determine an average of a square of each of the differences between the channel estimate of the selected carrier and the channel estimates of other carriers within the evaluation window, the estimation of the noise variance is further based on the average of the square of each of the differences.

In some embodiments, the detector is further configured to determine a log-likelihood ratio, estimate a signal to noise ratio, and/or perform a maximum ratio combining algorithm based on the noise variance.

In some embodiments, the selected one of the carriers within the evaluation window is a central carrier within the evaluation window.

In some embodiments, the samples are orthogonal frequency-division multiplexing samples.

In some embodiments, the radio frequency signal is encoded according to the Digital Audio Broadcast specification.

Another aspect is a method of estimating noise variance for a symbol of a radio frequency signal received by an apparatus, the method comprising: processing, by the front end circuit, a received radio frequency signal into a plurality of samples; converting at least one of the samples into a plurality of frequency carriers; determining, at a detector, a channel estimate for each of the frequency carriers located within an evaluation window; selecting, by the detector, one of the carriers within the evaluation window; determining differences between the channel estimate of the selected carrier and the channel estimates of other frequency carriers within the evaluation window; and estimating the noise variance for a symbol including the at least one of the samples based on the differences between the channel estimate of the selected carrier and the channel estimates of other carriers within the evaluation window.

In some embodiments, the method further comprises determining the noise variance for at least two symbols.

In some embodiments, the method further comprises determining a filtered noise variance for the radio frequency signal by applying an infinite impulse response filter to the noise variance for the at least two symbols.

In some embodiments, the method further comprises determining a square of each of the determined differences; summing the squares of the determined differences; and dividing the sum by a total number of the determined differences, the estimation of the noise variance is further based on the sum the squares of the determined differences divided by the total number of the determined differences.

In some embodiments, the method further comprises determining an average of a square of each of the differences between the channel estimate of the selected carrier and the channel estimates of other carriers within the evaluation window, the estimation of the noise variance is further based on the average of the square of each of the differences.

In some embodiments, the method further comprises determining a log-likelihood ratio, estimating a signal to noise ratio, and/or performing a maximum ratio combining algorithm based on the noise variance.

In some embodiments, the selected one of the carriers within the evaluation window is a central carrier within the evaluation window.

Yet another aspect is a digital radio system comprising: a radio receiver including an antenna configured to receive a radio frequency signal, a low noise filter configured to process the radio frequency signal into a plurality of samples, a transform engine configured to convert at least one of the samples into a plurality of frequency carriers, and a detector coupled to the transform engine and configured to determine a channel estimate for a subset of the frequency carriers located within an evaluation window, select one of the carriers within the evaluation window, determine differences between the channel estimate of the selected carrier and the channel estimates of other carriers within the evaluation window, and estimate noise variance for a symbol including the at least one of the samples based on the differences between the channel estimate of the selected carrier and the channel estimates of other frequency carriers within the evaluation window.

In some embodiments, the detector is further configured to determine the noise variance for at least two symbols.

In some embodiments, the detector is further configured to determine a filtered noise variance for the radio frequency signal by applying an infinite impulse response filter to the noise variance for the at least two symbols.

In some embodiments, the detector is further configured to determine a square of each of the determined differences, sum the squares of the determined differences, and divide the sum by a total number of the determined differences, the estimation of the noise variance is further based on the sum the squares of the determined differences divided by the total number of the determined differences.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the disclosure. In the figures, each identical or nearly identical component that is illustrated in various figures is represented by a like numeral. For purposes of clarity, not every component may be labeled in every figure. In the figures:

FIG. 1A is a graphical illustration of a plurality of frequency carriers for multiple OFDM symbols having DEQPSK modulation.

FIG. 1B is a graphical illustration of a received signal via a channel.

FIG. 2A is a schematic diagram of an example radio system according to an embodiment.

FIG. 2B is a block diagram of a receiver in accordance with aspects of this disclosure.

FIG. 3A illustrates a three-dimensional plot of the OFDM modulated frequency carriers in the frequency and time dimensions with the magnitude of each carrier shown in the Z-direction.

FIG. 3B illustrates a two-dimensional plot of the OFDM modulated frequency carriers with the magnitude information removed.

FIGS. 4A-4D provide graphical illustrations of channel estimation and noise variance estimation in accordance with aspects of this disclosure.

FIG. 5 is a flow diagram of a method for estimating noise variance in accordance with aspects of this disclosure.

FIG. 6 is a schematic block diagram of a digital radio baseband processor 640 according to an embodiment.

### DETAILED DESCRIPTION

Aspects and embodiments described herein are directed to systems and methods for estimating noise variance (also referred to “interference variation”). Noise variance can be used by multiple different component in the signal processing path of an orthogonal frequency-division multiplexing (OFDM) receiver.

Traditional techniques for estimating noise variance can be inaccurate, particularly in conditions where noise variance estimation techniques cannot not rely on pilots or other reference signals. Thus, aspects of this disclosure relate to more accurate and/or precise estimates of noise variance can be used to improve an OFDM receiver's performance in conditions where noise interference power is not constant.

### Introduction to Radio Systems

In various embodiments, a radio receiver is configured to estimate noise variance for an incoming radio frequency (RF) signal. The noise variance estimate can be used, for example, to scale log-likelihood ratio (LLR) values provided to a decoder, as an input for maximum ratio combining (MRC) algorithms for multi-antenna receivers, and/or for signal to noise ratio (SNR) metric estimation.

Embodiments may be used in a variety of receiver implementations for determining and using noise variance estimates as a part of decoding incoming orthogonal frequency division multiplexing (OFDM) communications. While embodiments are not limited in this regard, implementations may be used in connection with a Digital Audio Broadcast (DAB) digital radio communication system according to a given specification. Other implementations can be used in connection with other digital communication techniques, including wireless local area networks or other receivers using OFDM signaling.

An OFDM signal is processed mostly in the frequency domain. Due to the properties of OFDM modulation in which message information includes a cyclic prefix and message content, each signal can be presented as:

$${Y}_{i} = {X}_{i} {H}_{i} + {N}_{i} \qquad [ Equation 1 ]$$

where:
Yi is the complex value of an input signal at frequency i,
Hi is the complex value of the channel at frequency i,
Xi is the complex value of the transmitted modulation symbol i, and
Ni is the complex gaussian noise sample.

In a DAB symbol stream in which differentially encoded quadrature phase shift keying (DEQPSK) OFDM symbols are communicated, there are no pilot or other reference signals at known locations that can be used for estimating noise variance. As such, noise variance estimates may be performed using noise variance estimation techniques that do not rely on pilots or other reference signals.

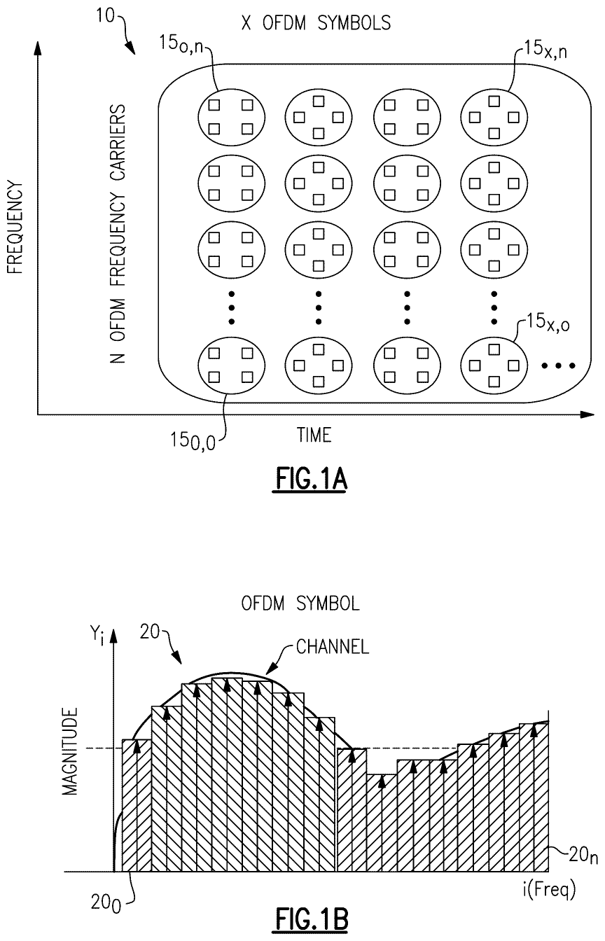

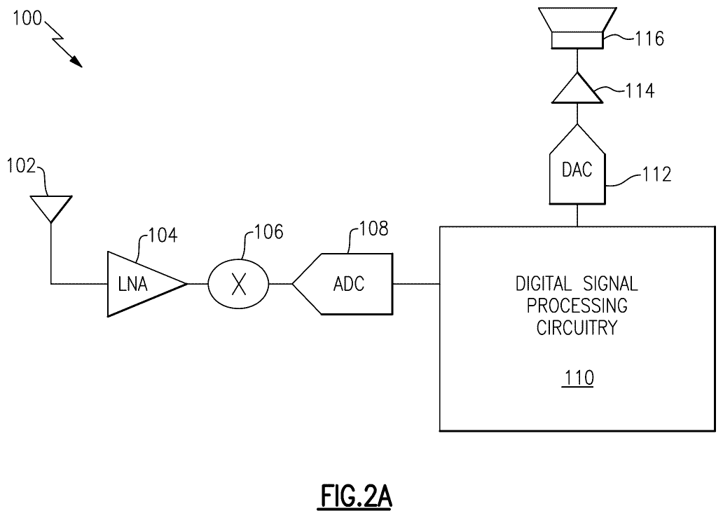

Referring now to FIG. 1A, shown is a graphical illustration of a plurality of frequency carriers for multiple OFDM symbols having DEQPSK modulation. More specifically as shown in FIG. 1A, graphical illustration 10 includes multiple OFDM symbols (e.g., X OFDM symbols) 15₀-15_{X}. After conversion from the time domain to the frequency domain, each OFDM symbol 15 is represented by a plurality of OFDM frequency carriers (e.g., N frequency carriers) such that each OFDM symbol 15 is represented by a plurality of frequency carriers 15_{0, 0}-15_{0, n}. In some embodiments, the four constellation points of each succeeding OFDM symbol 15 are phase shifted from its predecessor by 45°. In a DEPSK modulation scheme, information is encoded in the change of phase of every frequency carrier 15_{0, 0}-15_{0, n}. In a DAB system implementation, a communication frame may include 76 OFDM symbols, where each OFDM symbol is transformed, e.g., in a fast Fourier transform (FFT) engine, into 2048 frequency bins, with 1536 frequency bins carrying data.

Referring now to FIG. 1B, shown is a graphical illustration of a received signal via a channel. As shown in FIG. 1B, an OFDM symbol 20, after conversion to the frequency domain, includes a plurality of frequency carriers 20₀-20ₙ. Given a channel having some level of impairment, frequency carriers 20 have different magnitudes and phases.

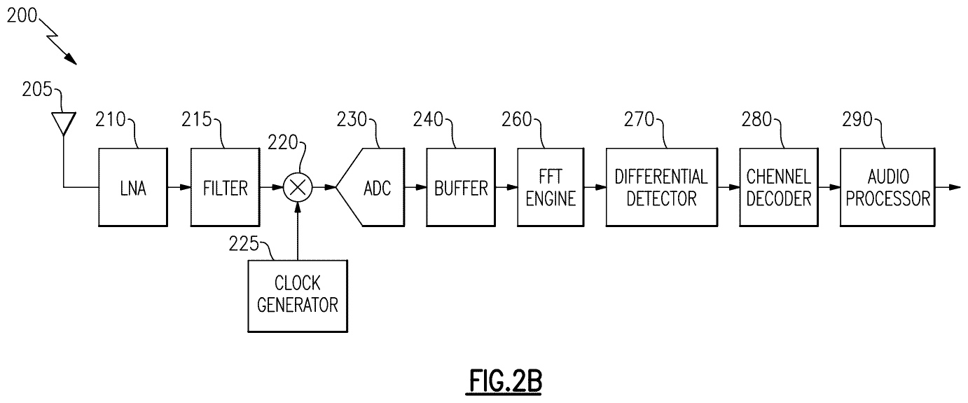

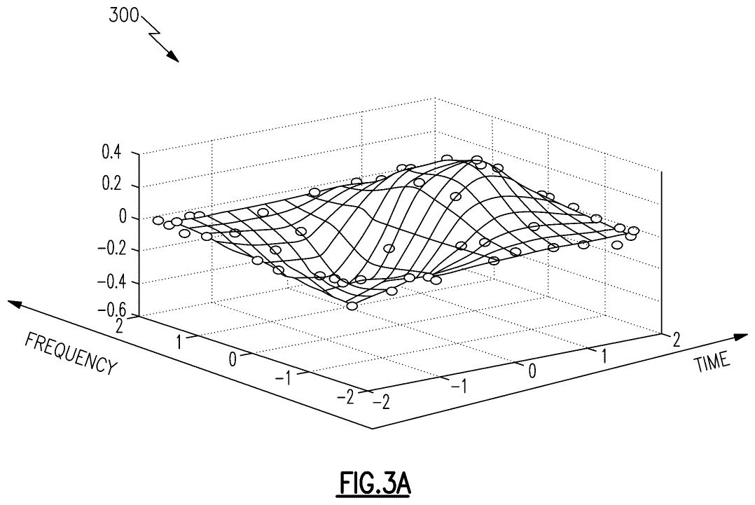

FIG. 2A is a schematic diagram of an example radio system 100 according to an embodiment. The radio system 100 can receive and process a digital radio signal. The radio system 100 can generate audio from the digital radio signal. The radio system 100 can process a digital radio signal that is in accordance one or more suitable digital radio standards, such as one or more of National Radio System Committee (NRSC-5C, also known as HD™ radio), DAB, Digital Radio Mondiale (DRM), Convergent Digital Radio (CDR), or another digital radio standard. As illustrated, the radio system 100 includes an antenna 102, a low noise amplifier 104, an analog-to-digital converter (ADC) 108, digital signal processing circuitry 110, a digital-to-analog converter (DAC) 112, an amplifier 114, and a speaker 116.

The radio system 100 is an example system that can process a received digital radio signal in accordance with any suitable principles and advantages disclosed herein. The digital signal processing circuitry 110 can estimate noise variance of the received digital radio signal in accordance with any suitable principles and advantages disclosed herein. The radio system 100 can be configured for receiving and processing the OFDM radio signals.

With reference to the radio system 100 of FIG. 2A, a radio frequency signal that includes digital radio signals according to a given digital broadcast specification can be received via the antenna 102. In some instances, the radio frequency signal can be received via two or more antennas.

A radio frequency signal received via the antenna 102 can be processed by a receive signal path and provided to the digital signal processing circuitry 110. The radio frequency signal path includes at least a low noise amplifier (LNA) 104, a mixer 106, and an analog-to-digital converter 108. In some instances, the radio frequency signal path can include additional circuit elements, such as one or more filters, one or more amplifiers with automatic gain control, etc. A radio frequency signal received via 102 can be amplified by the LNA 104. The amplified RF signal can be downconverted by the mixer 106. The downconverted signal generated by the mixer 106 can be a low-intermediate frequency (IF) signal or a zero-IF signal, for example. The downconverted signal can include an in-phase/quadrature phase (IQ) signal. The ADC 108 can digitize the downconverted signal into a digital signal.

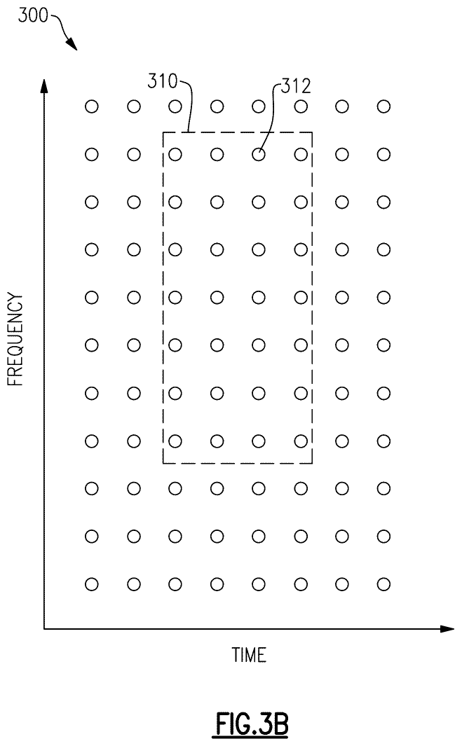

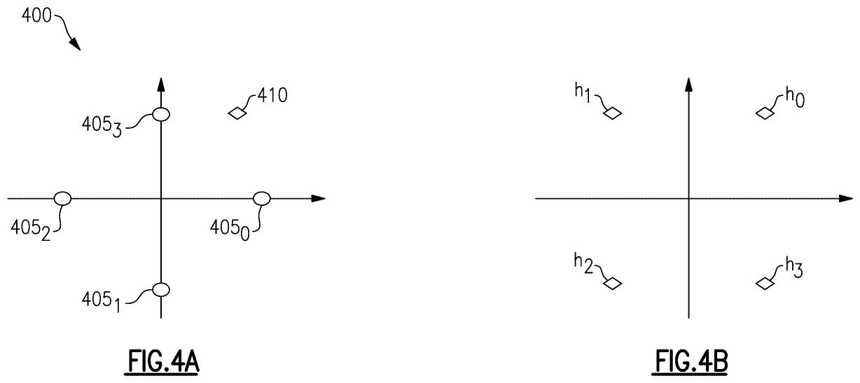

The digital signal processing circuitry 110 can perform any suitable processing on the digitized signal provided by the ADC 108. For example, the digital signal processing circuitry 110 can estimate the noise variance of the digital signal as described with reference to one or more of FIGS. 3A-5. The digital signal processing circuitry 110 can use the estimated noise variance as part of decoding the digital radio frequency signal in accordance with any suitable principles and advantages disclosed herein. The digital signal processing circuitry 110 can generate an audio output signal.

The audio output signal can be converted from a digital signal to an analog signal by a digital-to-analog converted (DAC) 112. The analog audio signal can be amplified by amplifier 114. The amplified analog audio signal can be provided to a speaker 116. The speaker 116 can output audio. While one speaker is shown in FIG. 2A, audio can be output from any suitable number of speakers based on one or more audio signals provided by the digital signal processing circuitry 110.

Referring now to FIG. 2B, shown is a block diagram of a receiver in accordance with aspects of this disclosure. As shown in FIG. 2B, receiver 20₀ may include a signal processing path having various components. Embodiments can be incorporated in different types of receiver systems. In some embodiments, receiver 20₀ may be a single-die integrated circuit such as a complementary metal-oxide-semiconductor (CMOS) die having mixed signal circuitry including both analog and digital circuitry.

With reference to receiver 20₀, an incoming RF signal that includes digital radio signals according to a given digital broadcast specification may be received over the air via an antenna 205. As used herein, the terms “digital radio” or “digital radio broadcast signal” are used interchangeably and are intended to correspond to broadcast radio communication that occurs digitally. Such communications may be in accordance with various standards such as a DAB or other standard.

As shown in FIG. 2B, an incoming RF signal received via antenna 205 is provided to a low noise amplifier (LNA) 210, which amplifies the RF signal. In turn, LNA 210 is coupled to a filter 215, which may perform filtering of the received RF signal. In the embodiment of FIG. 2B, the receiver 20₀ can include an RF front end that includes the LNA 210 and the filter 215. It will be understood that while shown with two RF front end blocks, a receiver 20₀ may include additional RF front end circuitry in other examples. In turn, the filtered RF signal is provided to a mixer 220, which in an embodiment may be implemented as a complex mixer. In embodiments herein mixer 220 may downconvert the RF signal to a lower frequency signal using a mixing signal received from a clock generator 225. In an embodiment, clock generator 225 may be implemented as a local oscillator, phase lock loop, or any other such clock generation circuit. In a particular embodiment, this lower frequency signal may be, e.g., a low-intermediate frequency (IF) or zero-IF signal. This downconverted signal may be an in-phase/quadrature phase (IQ) signal.

The resulting downconverted signal is provided to an analog-to-digital converter (ADC) 230, where the signal can be digitized into a digital signal. Note that in some embodiments, either before or after digitization, channelization may be performed to generate a channelized signal. In an OFDM system, a plurality of samples forms an OFDM symbol of an incoming data stream. Thus, the ADC can convert the received analog signal into digital symbols that can be processed by the components downstream from the ADC 230.

In turn, samples are provided to a buffer 240, which may be implemented as a first in first out (FIFO) buffer. The incoming samples are stored in buffer 240, and are then output to a main digital signal processing path including a fast Fourier transform (FFT) engine 260, which generates frequency domain OFDM symbols from incoming time domain OFDM symbols. In one embodiment, each incoming time domain OFDM symbol can be processed by FFT engine 260 into a plurality of frequency carriers. Note that the number of frequency carriers corresponding to a given OFDM symbol may vary depending upon a particular radio standard, bandwidth of the signal, and/or time duration of the OFDM symbol (without cyclic prefix).

As further shown in FIG. 2B, frequency carriers generated in FFT engine 260 are provided to a differential detector 270 (also referred to as a “detector”). In embodiments herein, differential detector 270 may be a dedicated hardware circuit or a microcontroller or other control logic to execute instructions stored in a non-transitory storage medium such as firmware and/or software instructions. The differential detector 270 can include a coherent differential equalizer configured to perform channel estimations and use the channel estimate information to generate soft decisions, e.g., in the form of log likelihood ratio (LLR) values, as described herein. Of course, the differential detector 270 could be implemented in different ways in other embodiments.

In embodiments herein, differential detector 270 may generate LLR values for each pair of frequency carriers of the OFDM symbol. In turn, these LLR values may be provided to a channel decoder 280. In an embodiment, channel decoder 280 may be implemented as a Viterbi decoder to decode encoded message information based at least in part on the LLR values. Channel decoder also may be used to perform error correction and information bit extraction. The resulting demodulated signal may be provided to an audio processor 290 for audio processing. The encoded audio signal is then provided to an audio source decoder (not shown for ease of illustration in FIG. 2B) to generate source audio. Although shown as individual components, understand that portions of the receiver after ADC 230 to the end of the signal processing path of FIG. 2B can be implemented in a digital signal processor (DSP).

Referring now to FIGS. 3A and 3B, shown are graphical illustrations of a plurality of OFDM modulated frequency carriers in accordance with aspects of this disclosure. In particular, FIG. 3A illustrates a three-dimensional plot of the OFDM modulated frequency carriers in the frequency and time dimensions with the magnitude of each carrier shown in the Z-direction. FIG. 3B illustrates a two-dimensional plot of the OFDM modulated frequency carriers with the magnitude information removed.

As shown in FIGS. 3A and 3B, graphical illustration 300 shows a plurality of frequency carriers 312 (only a representative one of which is enumerated in FIG. 3B). As illustrated, for each time instant (on the X-axis) representing an OFDM symbol, a plurality of frequency carriers 312 are provided (illustrated on the y-axis).

As further shown in FIG. 3B, an evaluation window 310 is present. As will be described herein, samples within evaluation window 310 may be processed in determining LLR values for a given one or more of frequency carriers 312 within evaluation window 310. As such, evaluation window 310 may act as a moving window to enable efficient and accurate determination of LLR values for given frequency carriers. This is so, as typically the channel changes slowly in both frequency and time. As such, it may be assumed that within an evaluation window such as evaluation window 310, the channel is approximately constant.

### Techniques for Estimating Noise Variance

Noise variance (also referred to as “interference variation”) is a measure of the variance in the amount of noise and/or interference in an RF signal. In one example situation, the noise interference power may change when an automatic gain control (AGC) loop is applied. The AGC loop may apply gain changes to the power of internal thermal noise seen by the RF receiver. As another example situation, the interference power may change in response to varying power cochannel interference.

It can be important for an RF receiver to estimate the amount of noise variance as part of decoding a received RF signal. For example, the noise variance estimate can be used to scale log-likelihood ratio (LLR) values provided to a decoder, and/or as an input for maximum ratio combining (MRC) algorithms for multi-antenna receivers, and/or for signal to noise ratio (SNR) metric estimation. The accuracy of the noise variance estimate can directly affect the accuracy of the algorithms/estimations that rely on the noise variance estimate, thereby improving the decoder and MRC performances and providing a more accurate SNR metric.

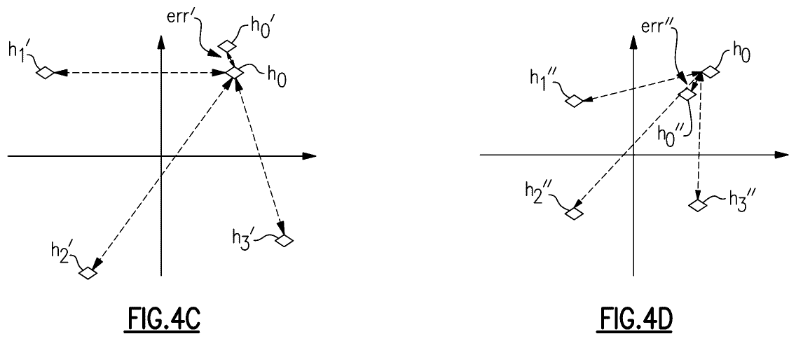

One factor that can complicate the estimation of noise variance within OFDM receivers is the presence of channel effects. Certain techniques for estimating noise variance, such as decision directed techniques, are not possible without channel knowledge. As used herein, channel knowledge may generally refer to some information that is indicative of the channel. For example, the channel knowledge may take the form of the complex value of the channel at a given frequency (see, for example, Hi of Equation 1). Some noise variance estimation techniques may require knowledge of a channel estimate (e.g., which channel estimate h₀-h₃ as shown in FIG. 4B is correct). In certain radio communication standards, channel knowledge can be provided in the form of pilots, which can be used for channel estimation, from which the noise variance can be estimated. When pilots are present, a decision directed algorithm can use the pilots to estimate the noise variance. However, in OFDM standards that do not include pilots (such as DAB), decision directed algorithms cannot be used to estimate noise variance.

To overcome this challenge, one technique for estimating noise variance determine the magnitude of the FFT and use the difference between two neighbor carrier magnitudes to estimate noise and/or interference. This process may be based on the assumption that the channel does not change between neighbor symbols. A disadvantage to this approach is that magnitude information is used without using any phase information, and thus, the noise variance estimate is less accurate that would be possible using both magnitude and phase information.

Aspects of this disclosure relate to techniques that can improve the estimation of noise variance, particularly in OFDM communication standards that do not include pilots. For example, a radio receiver can include a front end circuit configured to receive a radio frequency signal and process the radio frequency signal into a plurality of samples. The receiver can also include a transform engine coupled to the front end circuit and configured to convert at least one of the samples into a plurality of frequency carriers. The receiver may also include a detector coupled to the transform engine and configured to determine a channel estimate for a subset of the frequency carriers located within an evaluation window, select one of the carriers within the evaluation window, determine differences between the channel estimate of the selected carrier and the channel estimates of other carriers within the evaluation window, and estimate the noise variance for the at least one of the samples based on the differences between the channel estimate of the selected carrier and the channel estimates of other frequency carriers within the evaluation window. Advantageously, these techniques can improve an OFDM receiver's performance in conditions where noise interference power is changing over time.

As described above in connection with FIGS. 3A and 3B, the channel typically changes slowly in both frequency and time. As such, it may be assumed that within an evaluation window such as evaluation window 310, the channel is approximately constant.

FIGS. 4A-4B provide graphical illustrations of channel estimation and noise variance estimation in accordance with aspects of this disclosure. As discussed above, the differential detector 270 can be configured to perform channel estimations for the frequency carriers 312. Referring now to FIG. 4A, shown is a graphical illustration of a channel estimation for a frequency carrier in accordance with aspects of this disclosure. As shown in FIG. 4A, graphical illustration 400 presents four possible modulation points 405₀-405₃ for a frequency carrier. As further shown, a received signal Yi 410 also is illustrated. Note that there may be multiple possible channel estimates per frequency carrier. For example, in DAB there are four possible channel estimates per frequency carrier, one per possible decision (DQPSK).

Given four modulation points, {1, j, −1, −j}, there are four possible channel estimates that can be obtained from a received signal, Yi. Since h_est=Yi/mod_point, the four possible channel estimates are (Yi, −j*Yi, −Yi, j*Yi), one of which will fall on the received signal 410. Accordingly, referring now to FIG. 4B, shown is a graphical illustration of four possible channel estimates h₀-h₃ for a given frequency carrier.

A technique that can be implemented by a receiver 20₀ to estimate noise variance will now be described in connection with FIGS. 4B-4D. In some embodiments, the differential detector 270 may be configured to estimate the noise variance, however, aspects of this disclosure are not limited thereto and any one or more components of the receiver 20₀ can be configured to estimate the noise variance. For ease of description, the technique for estimating the noise variance will be described as being performed by the differential detector 270.

As discussed above, FIG. 4B illustrates four possible channel estimates h₀-h₃ for a given carrier when DQPSK encoded is used. Although certain communication standards, such as DQPSK, include only four possible channel estimates, the techniques disclosed herein can also be used to estimate noise variance for encoded standards that have a fewer or greater number of possible channel estimates. The number of channel estimates may correspond to the number of modulation points used by a given communication standard. For example, BPSK can have 2 modulation points while 16QAM can have 16 modulation points.

The differential detector 270 is configured to estimate the noise variance for any frequency carrier 312 within the evaluation window 310. The differential detector 270 can select any one of the frequency carrier 312 within the evaluation window 310 as a “selected” carrier 312. In some embodiments, the differential detector 270 can select a central carrier 312 within the evaluation window 310 for better performance, however, aspects of this disclosure are not limited thereto and the differential detector 270 may select any carrier within the evaluation window 310. For example, in some embodiments, the differential detector 270 may select a carrier 312 can on the edge of the evaluation window 310 when the selected carrier 312 is on an edge of the frequency axis.

The differential detector 270 can estimate four channels for the selected carrier 312 (e.g., the channel estimates h₀-h₃ shown in FIG. 4B). The 270 can select any one of the channel estimates h₀-h₃ as a channel estimate for the selected carrier 312. The selected channel estimate h₀-h₃ can be used for estimating the noise variance. The techniques for estimating the noise variation described herein may not change based on which of the channel estimates h₀-h₃ is selected as the channel estimate for the selected carrier 312. Thus, in some embodiments, the differential detector 270 may randomly select one of the four channel estimates h₀-h₃.

FIG. 4C is a graphical illustration of possible channel estimates h₀′-h₃′ for another frequency carrier 312 which can be compared to the selected frequency carrier 312 as part of estimating the noise variance. In this case, the channel estimate h₀ was selected as a channel estimate for the selected frequency carrier 312 to be used for estimating the noise variance. The differential detector 270 can determine the difference err′ between the channel estimate h₀ for the selected frequency carrier 312 and the possible channel estimates h₀′-h₃′ for the other frequency carrier 312. The differential detector 270 may determine the difference err′ based on the distance between the closest channel estimate, in this case h₀′, for the other frequency carrier 312 and the channel estimate h₀ for the selected frequency carrier 312.

FIG. 4D is a graphical illustration of possible channel estimates h₀″-h₃″ for yet another frequency carrier 312 which can be compared to the selected frequency carrier 312 as part of estimating the noise variance. As in the example of FIG. 4C, the channel estimate h₀ was selected as a channel estimate for the selected frequency carrier 312 to be used for estimating the noise variance. The differential detector 270 can determine the difference err″ between the channel estimate h₀ for the selected frequency carrier 312 and the possible channel estimates h₀″-h₃″ for the frequency carrier 312 shown in FIG. 4D. The differential detector 270 may determine the difference err″ based on the distance between the closest channel estimate, in this case h₀″, for the other frequency carrier 312 and the channel estimate h₀ for the selected frequency carrier 312.

In some embodiments, the differential detector 270 may estimate the noise variance for a selected one of the carriers 312 within the evaluation window 310. For example, the differential detector 270 can determine the noise variance based on the difference between the channel estimate of the selected carriers 312 and the channel estimates for all other carriers 312 in the evaluation window 310. In some embodiments, the differential detector 270 can select the central carrier 312 as the selected carrier 312 and compare the channel estimate of the central carrier 312 to the channel estimates of the remaining carriers 312. However, embodiments of this disclosure are not limited thereto and any one of the carriers 312 within the evaluation window 310 can be selected for comparison to the remaining carriers 312.

The differential detector 270 can determine the square of each of the differences between the channel estimate of the selected carrier 312 and the channel estimates for all other carriers 312 in the evaluation window 310. The differential detector 270 can further determine the sum of all of the squared differences, and divide the sum by the total number of differences calculated. Thus, in some embodiments, the differential detector 270 can determine the average of the squared differences between the channel estimate of the selected carrier 312 and the channel estimates for all other carriers 312 in the evaluation window 310. In some embodiments, the differential detector 270 can use the average of the squared differences as the noise variance for the selected carrier 312.

In some embodiments, the differential detector 270 can estimate the noise variance of the selected carrier 312 according to the following equation:

$${σ}^{2} ( l , m ) = \frac{1}{M * L - 1} {\sum }_{i = l - L / 2}^{l + L / 2} {\sum }_{j = m - M / 2}^{m - M / 2} {\vert h - \vert}^{2} \qquad [ Equation 2 ]$$

Where:
σ²(l,m) is the noise variance for the selected (l,m) carrier 312 at symbol l (in time) and m (in frequency),
M,L are the dimensions of the evaluation window 310,
h [symbol] is the channel estimate of the selected (l,m) carrier 312, and
[symbol] is the channel estimate of the (i,j) carrier (e.g., other carriers 312 in the evaluation window 310).

As is expressed by Equation 2, the differential detector 270 can estimate the noise variance for the symbol based on the differences between the channel estimate of the selected carrier 312 and the channel estimates of the other carriers 312 in the evaluation window 310. In some embodiments, the differential detector 270 can estimate the noise variance based on a sum of the squares of the differences between the channel estimate of the selected carrier 312 and the channel estimates of the other carriers 312.

In some embodiments, the differential detector 270 is configured to estimate one noise variance value per window σ(l,m). For example, each window may correspond to time period in which the noise variance σ²(l,m) for the selected (l,m) carrier 312 at symbol (in time) and m (in frequency) is determined according to equation 2. Thus, the noise variance can be estimated for a given carrier in the window σ(l,m). The differential detector 270 can move window σ(l,m) up or down by one carrier and estimate a new noise variance value for a given carrier in the middle of the new window σ(l,m+1) or σ(l,m−1) respectively. When the differential detector 270 moves the window σ(l,m) up or down to the edge of the evaluation window 310 and the differential detector 270 can either make the evaluation window 310 smaller or stop moving the window σ(l,m) and change a given carrier to the next up/down (e.g., not in the center of the evaluation window 310). The differential detector 270 can create N noise variance estimates per a given OFDM symbol. Equation 3 (shown below) can average N number of frequency carriers per OFDM symbol to get one noise estimate per OFDM symbol.

Using the noise variance σ²(l,m) for the selected carrier 312, the differential detector 270 can estimate the noise variance per symbol σ²(l) (e.g., OFDM symbol). For example, the differential detector 270 can sum the noise variance σ²(l,m) for the selected carrier 312 over the range of frequencies in the symbol and divide the sum by the number of frequencies and use the resulting value as an estimate for the noise variance of the symbol.

In some embodiments, the differential detector 270 can estimate the noise variance of the symbol according to the following equation:

$${σ}^{2} ( l ) = \frac{1}{N} {\sum }_{m = 0}^{N - 1} {σ}^{2} ( l , m ) \qquad [ Equation 3 ]$$

Accordingly, the differential detector 270 can sum the noise variance σ²(l,m) for the selected carrier 312 over the range of frequencies for the symbol to estimate the noise variance per symbol σ²(l).

In some situations, the noise variance may change relatively slowly, for example, at substantially the same rate the AGC loop changes the gain. For example, this may be related to how fast total signal power changes. In some cases, noise variance can remain substantially constant when the signal power doesn't change. In these situations, the differential detector 270 can filter the noise variance (for example, using an infinite impulse response (IIR) filter) to smooth the noise variance. The IIR filter is configured to averaging the value of the noise variance over time, and thus, it is related to how fast AGC loop is adjusting. In some embodiments, the differential detector 270 can filter the noise variance according to the following equation:

$$= α * 1 ) + ( 1 - α ) * {σ}^{2} ( l ) \qquad [ Equation 4 ]$$

As shown in Equation 4, the differential detector 270 can smooth out changes in the noise variance per OFDM symbol σ²(l) using the IIR filter to determine the filtered noise variance per OFDM symbol [symbol] . The value α can be set between 0 and 1. In some embodiments, α can be set based on one or more characteristics of input power changes, for example, to average over shorter or longer time periods. As a is set closer to 0, previous measurements are given less weight, and as a is set closer to 1, previous measurements are given more weight. In the case that system noise is substantially constant, α can be set closer to one to average with as many past values as possible. In the case that system noise is changing very fast, α can be set closer to 0 to use a fewer number of past estimates. In some embodiments, the differential detector 270 can use a measurement window instead of IIR, for example, by using the last N noise estimates and average the last N noise estimates.

As discussed above, the differential detector 270 can use the estimated noise variance and/or the filtered noise variance to determine a log-likelihood ratio, estimate a signal to noise ratio, and/or perform a maximum ratio combining algorithm based on the noise variation.

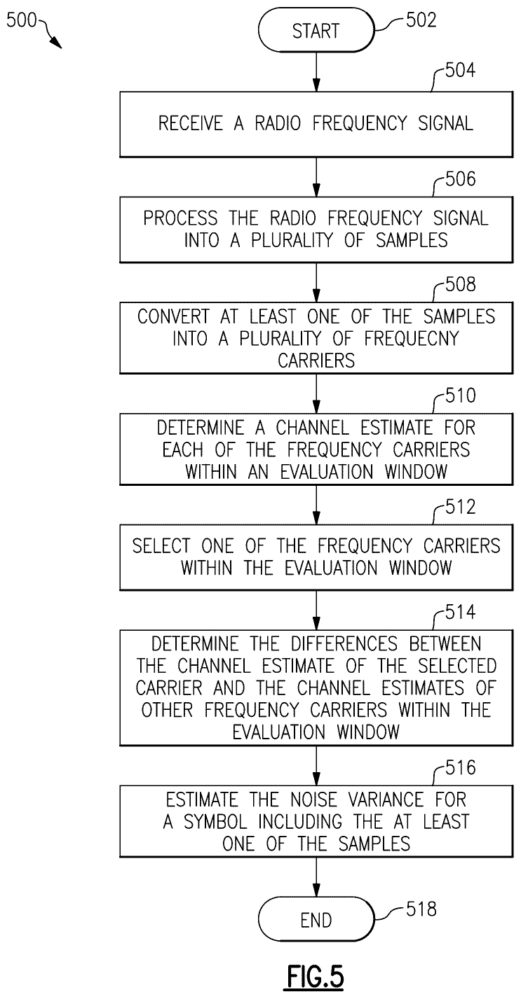

FIG. 5 is a flow diagram of a method for estimating noise variance in accordance with aspects of this disclosure. In some embodiments, the method 500 can be performed by a receiver (for example, by various components of the receiver 20₀) of FIG. 2A or 2B.

Referring to FIG. 5, at step 502, the method 500 begins. At step 504, the method 500 receives a radio frequency signal. In some embodiments, the radio frequency signal is received by a front end circuit of the receiver 20₀. The front end circuit can include, for example, the LNA 210, the filter 215, and/or one or more additional components.

At step 506, the method 500 processes the radio frequency signal into a plurality of samples. In some embodiments, the front end circuit can convert the radio frequency signal into the plurality of samples.

At step 508, the method 500 converts at least one of the samples into a plurality of frequency carriers. In some embodiment, a transform engine (such as the FFT engine 260 of FIG. 2B) can convert the samples into the frequency carriers.

At step 510, the method 500 determines, at a detector, a channel estimate for each of the frequency carriers located within an evaluation window. In some embodiments, a detector (such as the differential detector 270 of FIG. 2B) can determine the channel estimate for each of the frequency carriers located within an evaluation window. In some embodiments, a subset of the total number of the frequency carriers is located within the evaluation window as shown, for example, in FIG. 3B.

At step 512, the method 500 selects one of the carriers within the evaluation window. In some embodiments, the detector can select one of the carriers within the evaluation window. For example, the detector may select the central carrier within the evaluation window.

At step 514, the method 500 determines the differences between the channel estimate of the selected carrier and the channel estimates of other frequency carriers within the evaluation window. In some embodiments, the detector can determine these differences.

At step 516, the method 500 estimates the noise variance for the at least one of the samples based on the differences between the channel estimate of the selected carrier and the channel estimates of other carriers within the evaluation window. In some embodiments, the detector can estimate the noise variance for a symbol including the at least one sample. The method 500 ends at block 518.

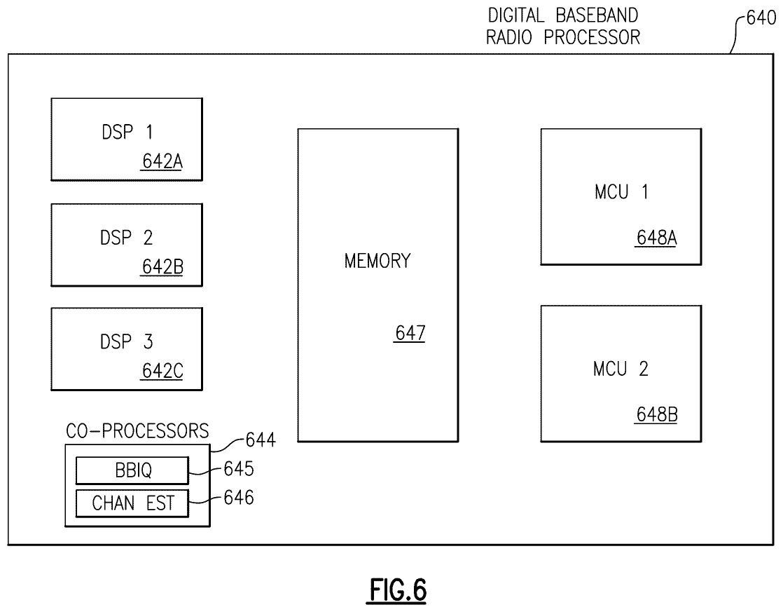

FIG. 6 is a schematic block diagram of a digital radio baseband processor 640 according to an embodiment. As illustrated, the digital radio baseband processor 640 includes a plurality of DSPs 642A, 642B, 642C, a plurality of co-processors 644 including a baseband IQ (BBIQ) co-processor 645 and a channel estimation co-processor 646, a memory 647, and microcontrollers (MCUs) 648A and 648B.

In certain applications, the techniques for estimating of noise variance disclosed herein can be implemented in a single DSP 642A with help from the BBIQ co-processor 645 and the channel estimation co-processor 646 in the digital radio baseband processor 640. In some other applications, the techniques for estimating of noise variance disclosed herein can be implemented in an application specific integrated circuit (ASIC) or a hardware accelerator.

Techniques for estimating of noise variance disclosed can be implemented in DAB radio system firmware. Offset compensation disclosed herein can be applied to other digital radio standards, including, but not limited to, NRSC-5C, DRM, and CDR. Offset compensation disclosed herein is applicable to other suitable OFDM standards including, but not limited to, WiFi and/or other IEEE 802.11 standards, Long Term Evolution (LTE), Digital Video Broadcasting-Terrestrial (DVB-T), etc.

### CONCLUSION

Any of the embodiments described above can be implemented in radio systems. The principles and advantages of the embodiments can be used for any systems or apparatus, such as any radio receiver, that could benefit from any of the embodiments described herein. The teachings herein are applicable to a variety of systems. In certain applications, radio systems disclosed herein are implemented in vehicles such as automobiles. Although this disclosure includes some example embodiments, the teachings described herein can be applied to a variety of structures.

Aspects of this disclosure can be implemented in various electronic devices. Examples of the electronic devices can include, but are not limited to, consumer electronic products, parts of the consumer electronic products, radio receivers, wireless communication infrastructure, electronic test equipment, etc. Examples of the electronic devices can include, but are not limited to, a stereo system, a digital music player, a radio, a vehicular electronics system such as an automotive electronics system, etc. Further, the electronic devices can include unfinished products.

Conditional language used herein, such as, among others, “can,” “could,” “might,” “may,” “e.g.,” “for example”, “such as” and the like, unless specifically stated otherwise, or otherwise understood within the context as used, is generally intended to convey that certain embodiments include, while other embodiments do not include, certain features, elements and/or states. The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively.

The examples shown in the figures illustrate the filter components or filtering stages as discrete “blocks”. Those skilled in the art will appreciate, given the benefit of this disclosure, that any or all of the filters shown in the various examples may be made up of many stages and/or combined or share components in different physical implementations. Accordingly, the examples shown in the figures are intended to be functional illustrations and not limiting in any aspect with respect to actual implementations of the radio frequency circuit assembly or front-end module. Aspects and embodiments provide a noise cancellation approach that can be designed into the overall front-end module configuration such that the overall filter out-of-band attenuations required can be relaxed, requirements on some or all the filter sections may be relaxed to provide more optimal and lower insertion losses, and the net insertion loss and out-of-band attenuation/isolation properties of the entire front-end module may exhibit less loss, more isolation, and more out-of-band attenuation where desired.

While certain embodiments have been described, these embodiments have been presented by way of example only, and are not intended to limit the scope of the disclosure. Indeed, the novel resonators, filters, modules, devices, wireless communication devices, apparatus, and systems described herein may be embodied in a variety of other forms. Furthermore, various omissions, substitutions and changes in the form of the resonators, filters, modules, devices, wireless communication devices, apparatus, and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and/or acts of the various embodiments described above can be combined to provide further embodiments. Accordingly, the foregoing description and drawings are by way of example only, and the scope of the disclosure should be determined from proper construction of the appended claims, and their equivalents.

What is claimed is:

1. An apparatus comprising:
a front end circuit configured to receive a radio frequency signal and process the radio frequency signal into a plurality of samples;
a transform engine coupled to the front end circuit and configured to convert at least one of the samples into a plurality of frequency carriers; and
a detector coupled to the transform engine and configured to determine a channel estimate for a subset of the frequency carriers located within an evaluation window, select one of the carriers within the evaluation window, determine differences between the channel estimate of the selected carrier and the channel estimates of other carriers within the evaluation window, and estimate noise variance for a symbol including the at least one of the samples based on the differences between the channel estimate of the selected carrier and the channel estimates of other frequency carriers within the evaluation window.

2. The apparatus of claim 1 wherein the detector is further configured to determine the noise variance for at least two symbols.

3. The apparatus of claim 2 wherein the detector is further configured to determine a filtered noise variance for the radio frequency signal by applying an infinite impulse response filter to the noise variance for at least two symbols.

4. The apparatus of claim 1 wherein the detector is further configured to determine a square of each of the determined differences, sum the squares of the determined differences, and divide the sum by a total number of the determined differences, the estimation of the noise variance is further based on the sum the squares of the determined differences divided by the total number of the determined differences.

5. The apparatus of claim 1 wherein the detector is further configured to determine an average of a square of each of the differences between the channel estimate of the selected carrier and the channel estimates of other carriers within the evaluation window, the estimation of the noise variance is further based on the average of the square of each of the differences.

6. The apparatus of claim 1 wherein the detector is further configured to determine a log-likelihood ratio, estimate a signal to noise ratio, and/or perform a maximum ratio combining algorithm based on the noise variance.

7. The apparatus of claim 1 wherein the selected one of the carriers within the evaluation window is a central carrier within the evaluation window.

8. The apparatus of claim 1 wherein the samples are orthogonal frequency-division multiplexing samples.

9. The apparatus of claim 1 wherein the radio frequency signal is encoded according to the Digital Audio Broadcast specification.

10. A method of estimating noise variance for a symbol of a radio frequency signal received by an apparatus, the method comprising:
processing, by the front end circuit, a received radio frequency signal into a plurality of samples;
converting at least one of the samples into a plurality of frequency carriers;
determining, at a detector, a channel estimate for each of the frequency carriers located within an evaluation window;
selecting, by the detector, one of the carriers within the evaluation window;
determining differences between the channel estimate of the selected carrier and the channel estimates of other frequency carriers within the evaluation window; and
estimating the noise variance for a symbol including the at least one of the samples based on the differences between the channel estimate of the selected carrier and the channel estimates of other carriers within the evaluation window.

11. The method of claim 10 further comprising determining the noise variance for at least two symbols.

12. The method of claim 11 further comprising determining a filtered noise variance for the radio frequency signal by applying an infinite impulse response filter to the noise variance for the at least two symbols.

13. The method of claim 10 further comprising:
determining a square of each of the determined differences;
summing the squares of the determined differences; and
dividing the sum by a total number of the determined differences, the estimation of the noise variance is further based on the sum the squares of the determined differences divided by the total number of the determined differences.

14. The method of claim 10 further comprising determining an average of a square of each of the differences between the channel estimate of the selected carrier and the channel estimates of other carriers within the evaluation window, the estimation of the noise variance is further based on the average of the square of each of the differences.

15. The method of claim 10 further comprising determining a log-likelihood ratio, estimating a signal to noise ratio, and/or performing a maximum ratio combining algorithm based on the noise variance.

16. The method of claim 10 wherein the selected one of the carriers within the evaluation window is a central carrier within the evaluation window.

17. A digital radio system comprising:
a radio receiver including an antenna configured to receive a radio frequency signal, a low noise filter configured to process the radio frequency signal into a plurality of samples, a transform engine configured to convert at least one of the samples into a plurality of frequency carriers, and a detector coupled to the transform engine and configured to determine a channel estimate for a subset of the frequency carriers located within an evaluation window, select one of the carriers within the evaluation window, determine differences between the channel estimate of the selected carrier and the channel estimates of other carriers within the evaluation window, and estimate noise variance for a symbol including the at least one of the samples based on the differences between the channel estimate of the selected carrier and the channel estimates of other frequency carriers within the evaluation window.

18. The digital radio system of claim 17 wherein the detector is further configured to determine the noise variance for at least two symbols.

19. The digital radio system of claim 18 wherein the detector is further configured to determine a filtered noise variance for the radio frequency signal by applying an infinite impulse response filter to the noise variance for the at least two symbols.

20. The digital radio system of claim 17 wherein the detector is further configured to determine a square of each of the determined differences, sum the squares of the determined differences, and divide the sum by a total number of the determined differences, the estimation of the noise variance is further based on the sum the squares of the determined differences divided by the total number of the determined differences.
